(19) United States
(12) Patent Application Publication
(10) Pub. No.: US 2005/0167144 A1
(43) Pub. Date: Aug. 4, 2005

(54) String-shaped product with connecting and/or fixing means

(76) Inventor: Christoph Studer, Gretzenbach (CH)

Correspondence Address: WENDEROTH, LIND & PONACK, L.L.P., 2033 K STREET N. W., SUITE 800, WASHINGTON, DC, 20006-1021, US

(21) Appl. No.: 10/513,912

(22) PCT Filed: May 15, 2003
(86) PCT No.: PCT/CH03/00315

(30) Foreign Application Priority Data
May 15, 2002 (CH) 814/02

(51) Int. Cl. H01B 7/18

(52) U.S. Cl. 174/74 R; 264/241; 428/583

(57) ABSTRACT

The invention relates to an electric cable having connecting means, for instance sensor means, and to a method for the production of said cable. In a preferred embodiment of the invention, the cable is configured as a sensor cable, wherein the lead insulation of the cable has a polymer layer containing a polyamide, a polyolefin or a blend thereof. In said case, the sensor cable can be produced as follows: after extruding the raw cable, the latter is cut into individual cable sections in non-crosslinked state. Said sections are then connected to a sensor in an electrically conductive manner. According to the invention, the housing of the sensor consists of a plastic material that is compatible with the lead insulation and that is radiation crosslinkable, said plastic material containing, for example, at least one polyamide, a polyolefin or a polyethylene. The polymers of the lead insulation and the polymers of the sensor housing disclosed in the invention are selected in such a way that they are crosslinkable with themselves and with one another once the sensor cable has been assembled. If necessary, a compatibilizer (e.g. block copolymer) or a reactive terpolymer enabling connection of functional groups between the layers can also be added to the lead insulation and/or the plastic housing. Finally, the plastic materials of the lead insulation and the sensor housing are crosslinked in a separate crosslinking process under the effect of high-energy electron radiation.

### TECHNICAL BACKGROUND

The invention concerns string-shaped or tape-shaped extruded linear products that incorporate at their ends thermoplastic end pieces or fixing means, whereby the same themselves are radiation crosslinked together with the linear product during production.

The invention further concerns a method that is especially suited for the production of such a product.

Electric cables with welded or moulded connecting means are an example of such string-shaped products.

Electric cables according to this invention are for example equipped with a sensor means for measuring the rotation speed of a motor, gears, or a wheel at one end and incorporate an isolation, which is resistant against liquid, steam, or gaseous media depending on the use, and which may possibly include high resistance against mechanical wear.

### PRIOR ART

Sensor cables of this type are for example used within the automotive industry, the rail and aircraft as well as spacecraft industry. They must satisfy special requirements especially for these applications and incorporate lead isolation with special characteristics. Amongst others the latter must therefore be
oil resistant and resistant against various chemicals,
flame resistant and environmentally friendly,
temperature and friction resistant as well as
mechanically robust
resistant against ageing and reliable
flexible and environmentally resistant.

The interface via which the sensor means is connected to the cable must also satisfy these requirements at least in part.

For the production of isolated electric cables that develop a minimum of smoke in case of fire as well as no and/or only very small quantities of toxic gas halogen-free isolation material is used today, such as for example polyethylene, ethylene copolymers, and other polymers that can be irradiated.

The flame resistance of halogen-free isolation material is—as is already known—achieved with an addition of aluminium trihydrate (ATH) and/or magnesium hydroxide. Electric cables with halogen-free isolation that incorporate such hydrates are known to suffer from the disadvantage of a reduced resistance against liquid media such as for example petrol, mineral oils, and organic solvents. In order to overcome this disadvantage the electric cables are equipped with a two-layer lead isolation, which in turn consists of a halogen-free inner isolation layer made from a flame resistant polymer, for example polyolefin-copolymer, and an outer protective layer made from a polyamide, a thermoplastic, halogen-free polyester elastomer, or a halogen-free, aromatic polyether. During the production of such electric cables polar polymers with oil-repellent characteristics are therefore selected for the chemically resistant outer layer. For the inner layer however plastics with good absorption characteristics for flame protection materials are available.

For the production of sensor cables the electric cable and the sensor, which in turn consist of an electronic component containing a housing with this part constructed from metal or plastic, are currently produced at separate industrial facilities and subsequently assembled at one of the two facilities or at a separate third facility to form the sensor cables. For this the cable sections intended for the production of the sensor cables are unwound from cable rolls, cut, and connected with the sensor during a separate working step, whereby the cable is first electrically conductively connected with the electronic component of the sensor, whereafter the sensor housing made of metal or plastic is affixed to the electronic component and welded or moulded to the cable sleeve.

A substantial disadvantage of this known process for the production of sensor cables consists of the fact that the two main components of the known sensor cable incorporate some physical characteristics that prevent an optimal connection of lead isolation with sensor housing. The plastic composition of the lead isolation with the material of the sensor housing is therefore not optimally compatible, even when the same also consists of plastic. This results in the fact that the preferably radiation crosslinked isolation layer of the electric cable adheres to the sensor housing only very badly, so that the oil and temperature resistance as well as the mechanical robustness, especially the extraction force, is limited far more than desired because of this. Known products also often show weaknesses when large temperature fluctuations occur and struggle to maintain their characteristics over extended time periods.

### PURPOSE OF THE INVENTION

It is the purpose of this invention to provide a novel electric cable with connecting means, especially a sensor cable of the type mentioned above, that does not incorporate the above mentioned disadvantages, and that is especially relatively easy to produce thanks to a logistically adapted method. The method shall be especially suitable also for the production of any other string-shaped products such as for example plastic pipes, plastic hoses, foils and foil laminate.

This task is solved in accordance with the invention by a string-shaped product, for example an electric cable, with the characteristics of claim 1 and a method with the characteristics of claims 8 and 9.

Preferred embodiments of the electric cable of this invention and the method of this invention are described in the subclaims.

### DESCRIPTION OF THE INVENTION

In one preferred embodiment of the invention the cable takes the form of a sensor cable, i.e. sensor line, and the lead isolation consists also of a flame resistant and halogen-free, radiation crosslinkable polymer layer, which in turn contains a polyamide, a polyolefin, or a polyolefin blend. Depending on the type and application of the string-shaped product all radiation crosslinkable plastics are suitable for the realisation of the invention, whereby halogen-containing plastics are especially suitable for higher temperatures, if this is an advantage, for example fluor-containing polymers.

In comparison the sensor of the known type consists of an electric component and a housing containing the same made from plastic. According to the invention the latter consists of a plastic or plastic mixture that is compatible with the lead isolation and itself radiation crosslinkable, containing for example at least one polyamide and/or a polyolefin, such as polyethylene. The polymers of the lead isolation and the polymers of the sensor housing are preferably selected in such a way that they can be moulded together in their assembled, but in a non-crosslinked state.

The sensor cable can be produced in this case as follows:
Following the extrusion of the preferably not crosslinked or only partially crosslinked raw lead the same is cut into individual cable sections which are then electrically conductively connected with a sensor at their ends in the known way.
Subsequently the plastic of the lead isolation and that of the sensor housing, connected with one another in their pre-produced form of the cable at least in part, for example moulded together, are crosslinked during a separate crosslinking process under the influence of energy-rich electron radiation. This will result in a connection of the polymers of the lead isolation with those of the sensor housing to form one polymer network, so that a predominantly mechanically resistant cable construction is created in this way.

In a further embodiment of the sensor cable described above the lead isolation consists of a co-extrudant, for example consisting of a flame resistant, halogen-free inner polymer layer and a chemically resistant, oil resistant, outer polymer layer especially adherent to, i.e. connected with the same and compatible with the same, which possibly also contains additional flame protection material. In this embodiment the inner layer incorporates at least one polyolefin or polyolefin blend, and the outer layer a polyester elastomer and/or a polyamide and/or a polyethylene, such as for example a high density polyethylene (HDPE). In addition the outer layer is also formed in such a way and adapted to the plastic composition of the sensor housing, that the same can be moulded to the sensor housing and radiation crosslinked in the way described above. The outer layer therefore normally consists of an extrudable plastic that can be crosslinked.

For the production of electric cables the raw cable is therefore cut into individual sections in this case also, which are then connected to a sensor at their ends, for example moulded. Following this at least the polymers of the outer layer of the lead isolation and the polymers of the sensor housing are treated under the influence of energy-rich electron radiation in such a way that the same crosslink to form one single polymer network.

Yet another embodiment of an electric cable according to this invention consists of several electric leads interwoven with one another.

Such a cable is equipped with a one- or two-layer sleeve and can be produced as follows.

On a copper braid, itself consisting of a multitude of individual wires with a total cross-section of 0.13 mm² to 16 mm² a normally radiation crosslinkable isolation layer is first applied. Two or more such isolated leads are then, usually following an interweaving process, coated with an outer sleeve layer through co-extrusion, for which two raw materials preferably belonging to the previously mentioned connection classes for the inner, i.e. outer layer of a lead isolation and intended for the formation of the inner and outer sleeve layers are supplied.

The inner material layer is preferably produced with a thickness of 0.1 to 2 mm, more preferably 0.2 to 1.5 mm, whilst the layer thickness of the outer layer can be relatively thin and generally consists of approximately 0.05 to 0.5 mm. If the outer layer does not contain a flame protection material the flame resistant characteristics of the entire lead isolation is provided by the inner layer. Accordingly it is important that the volume ration, i.e. the layer thickness ratio of the two layers is matched.

Due to their polymer composition both layers of the cable sleeve incorporate robust mechanical characteristics. Especially the inner layer thus incorporates a high tensile strength and high expansion capabilities, and the outer layer a high friction resistance.

Whilst the outer layer incorporates at least one polyester elastomer and/or a mechanically robust polymer and is selected primarily so that its plastic composition can be moulded to and crosslinked with the housing of the connecting means, for example the sensor, the inner layer can be formed differently depending on the application, for example with good absorption characteristics for flame protection material.

For the production of electric cables the raw cable is cut into individual cable sections in this case also, which are then connected to a sensor at their ends, whereby this results especially in the connection, and possibly the moulding of sensor housing and outer sleeve layer. Following this at least the polymers of the outer sleeve layer and the polymers of the sensor housing are treated under the influence of energy-rich electron radiation in such a way that the same crosslink to form a single polymer network.

The overall characteristics profile of the double-layer lead isolation or the possibly present double-layer cable sleeve is provided by a task distribution between the two layers of the same.

Suitable polyolefins for the formation of the single layer lead, the single layer sleeve, or the outer lead, i.e. sleeve layer according to the invention are the following polymer groups:
polyamides (PA)
polybutyleneterphthalate (PBTP)
polyethyleneterephtalate (PETP)
polyethylene copolymers, such as for example ethylene-vinyl-acetate (EVA), ethylene-methylacrylate (EMA), ethylene-butylacrylate (EBA)
EEA; EPDM; PE-C; PP;
polyethylene homopolymers;
maleic acid anhydride (MAH)-terpolymers;
glycidylmethacrylate (GMA)-terpolymers; polyvinylchloride; styrolpolymers; ABS; BS; PS halogenated polymers; CSM; ETFE; PEP; FPM; PE-C; PVC; PVDF; PVF;
elastomers and thermoplastic elastomers.

According to the invention the polymers of the inner lead and outer lead layer, i.e. the inner sleeve and the outer sleeve layer are selected in such a way that the same adhere to one another, i.e. are connected with one another in their applied, co-extruded condition, so that the mechanical friction resistance of the lead isolation is increased. In order to further increase adhesion between the two layers the at least one polymer of the inner layer and/or the at least one polymer of the outer layer can be equipped with an additional compatibilizer (for example a block polymer) or a reactive terpolymer, to enable a connection of functional groups between the layers.

Main characteristics of the possibly present outer lead or sleeve layers (as opposed to the total layer when the lead isolation or sleeve consists of one layer) for the connecting of the same with the sensor housing according to the invention are the mouldability and crosslinkability of the same with the plastic of the sensor housing, i.e. the material composition of the relevant layers is determined by the sensor housing.

The choice of material for use with this invention is therefore according to the following sequence:
1. For the sensor housing a heat-stable, crosslinkable, and possibly mouldable plastic should be chosen.
2. The cable enclosure should be chosen in such a way that the outer layer can be thermoplastically moulded to and crosslinked with the relevant plastic of the sensor housing.

As already mentioned above at least the outer layer of the lead isolation, i.e. the cable sleeve is radiation crosslinked with the sensor housing in the end product of this invention. If one also wants to crosslink the relevant inner layer in this particular embodiment the outer layer raw material must possibly be additionally equipped with low molecular crosslinking enhancers.

The sensor cable of this invention has the following physical characteristics:
It incorporates a high mechanical firmness, especially within the area of the cut between cable and sensor means, which is due amongst others to the moulding together and crosslinking of lead isolation, i.e. sleeve and sensor housing. It is tight and resistant to ageing across a wide temperature range without additional auxiliary elements.
Flame resistance tests are passed successfully by the double-layer lead isolation, i.e. sleeve isolation.
The sensor cable of this invention with its double-layer lead isolation is not only oil resistant. It is also resistant against other liquids, chemicals, and steam, such as for example antifreeze, battery fluid, windscreen washer fluid, brake fluid, detergents, motor and gearbox as well as hydraulic fluids and petrol.
It can be used without problems especially within the automotive industry, and there more specifically in connection with sensors for the measuring of rotation speed, torque, pressure, oxygen content, temperature, oil level, air quality, etc.

Finally is should be said that the above mentioned embodiments represent only a selection of several possible embodiments of the invention, and that the same can be varied and amended in many different ways. It is therefore possible to crosslink the ends of entire cable harnesses as a single component set during one working step instead of individual sensor cables. Such cable harnesses are often used within the automotive industry and consist for example of several interconnected cable sections.

It is further possible in line with the method of this invention to produce plastic pipes and hoses with welded coupling sections crosslinked with the pipe, i.e. the hose as well as foils and laminates with welded and crosslinked folds and edge areas. In this case also the string-shaped products produced according to the invention incorporate improved characteristics with regard to temperature resistance, friction resistance, sealing, and tear resistance. Finally the method of this invention can also be used with suitable plastic compositions to reinforce, i.e. freeze the shape and/or structure of a component, for example the shape of a coiled cable, which in turn consists at least in part of radiation crosslinkable components, during a final process step by crosslinking. This shape will then be maintained even at high operating temperatures.

1-11. (canceled)

12. String-shaped product, consisting at least in part of a thermoplastic plastic, with at least one envisaged connecting and/or fixing means, wherein the connecting and/or fixing means and the thermoplastic plastic contain compatible as well as crosslinkable polymers.

13. String-shaped product according to claim 12, wherein the same consists of an electric cable.

14. Electric cable according to claim 13, wherein the connecting means consists if a sensor, and in that the sensor cable produced in this way is intended for example for use within the machine industry, plant construction, the automotive industry, the rail or the aircraft and spacecraft industry.

15. Sensor cable according to claim 14, wherein the same consists of electrical conductor and a lead isolation surrounding the conductor, and in that the sensor consists of an electronic component and a plastic housing affixed onto and/or to the same, and in that the lead isolation and the housing of the sensor incorporate polymers that can be moulded together and crosslinked.

16. Sensor cable according to claim 14, wherein the lead isolation consists of a possibly flame resistant, halogen-free, crosslinkable polymer layer, which in turn contains a polyamide, a polyolefin, or a polyolefin blend.

17. Sensor cable according to claim 14, wherein the housing of the sensor consists of a plastic that is compatible with the lead isolation and possibly crosslinkable, containing for example at least a polyamide, a polyolefin, or a polyethylene. With subsequent radiation elastomers can also achieve the firmness that is required for the housing material.

18. Electric cable according to claim 13, wherein the same consists of several electric conductors and a sleeve enclosing the conductors, and in that a connecting means is envisaged in one end of the cable, which in turn consists of an electronic component and a plastic housing affixed onto and/or to the same, wherein the sleeve and the housing of the connecting means contain polymers that can be moulded and crosslinked.

19. Method for the production of a string-shaped product with at least one radiation crosslinkable component, whereby the product is brought into a predetermined structural shape in its thermoplastic condition, wherein the polymers of the string-shaped product are crosslinked during a final process step, to reinforce, i.e. emboss the predetermined structure in this way.

20. Method, especially for the production of a string-shaped product according to claim 12, wherein at least one connecting and/or fixing means is connected to the string-shaped product in its thermoplastic condition, and in that subsequently the polymers of the string-shaped product and the polymers of the housing of the connecting and/or fixing means are crosslinked.

21. Method for the production of an electric cable according to claim 20, wherein the non-crosslinked raw cable is cut into individual cable sections, which are then each connected with a connecting means, for example a sensor, at their ends in an electrically conductive way, and possibly thermoplastically moulded, and in that the polymers of the lead isolation, i.e. the sleeve, and the polymers of the sensor housing are then crosslinked.

22. Method according to claim 20, wherein the polymers are crosslinked under the influence of energy-rich electron radiation.

23. Sensor cable according to claim 15, wherein the lead isolation consists of a possibly flame resistant, halogen-free, crosslinkable polymer layer, which in turn contains a polyamide, a polyolefin, or a polyolefin blend.

24. Sensor cable according to claim 15, wherein the housing of the sensor consists of a plastic that is compatible with the lead isolation and possibly crosslinkable, containing for example at least a polyamide, a polyolefin, or a polyethylene. With subsequent radiation elastomers can also achieve the firmness that is required for the housing material.

25. Sensor cable according to claim 16, wherein the housing of the sensor consists of a plastic that is compatible with the lead isolation and possibly crosslinkable, containing for example at least a polyamide, a polyolefin, or a polyethylene. With subsequent radiation elastomers can also achieve the firmness that is required for the housing material.

26. Method according to claim 21, wherein the polymers are crosslinked under the influence of energy-rich electron radiation.
